(19) United States
(12) Patent Application Publication
(10) Pub. No.: US 2026/0117050 A1
(43) Pub. Date: Apr. 30, 2026

(54) METHODS FOR COATING GRANULES AND THE GRANULES THEREOF

(71) Applicant: CERTAINTEED LLC, Malvern, PA (US)

(72) Inventors: Erin Lynn CAMPONESCHI BROTHERSON, Avondale, PA (US); Kevin GALLOWAY, Havertown, PA (US); Julie TINKLENBERG, Downingtown, PA (US); Brent SMITH, Pottstown, PA (US); Anvay Arun PATIL, Downington, PA (US); Francisco Javier CEDANO SERRANO, Speyer (DE)

(21) Appl. No.: 19/003,388

(22) Filed: Dec. 27, 2024

Related U.S. Application Data
(60) Provisional application No. 63/615,551, filed on Dec. 28, 2023.

(51) Int. Cl. C08K 9/08

(52) U.S. Cl. CPC C08K 9/08

(57) ABSTRACT

A granule for use in a building product, the granule having a core, a coating overlying the core, and an asphalt-containing region disposed between the core and the coating.

### CROSS-REFERENCE TO RELATED APPLICATION(S)

This Application claims priority under 35 U.S.C. § 119(e) to U.S. Provisional Ser. No. 63/615,551 , entitled “METHODS FOR COATING GRANULES AND THE GRANULES THEREOF,” by Erin Lynn CAMPONESCHI BROTHERSON, filed Dec. 28, 2023, which is assigned to the current assignee hereof and is incorporated herein by reference in its entirety.

### BACKGROUND

### Field of the Disclosure

The following is directed to a method for coating granules, and in particular, granules including reclaimed granules.

### Description of the Related Art

Building products come in a variety of forms and the market for new building products is expanding. Certain building products, including roofing products, are made of a base material and a bituminous material. Conventionally, the bituminous material can include asphalt, filler, and other additives depending upon the intended use. A variety of fillers have been used including limestone, talc, fly ash, coal fines, or other relatively inert materials. Depending on the applications, building products may also include one or more layers of granulated material for improving the performance and/or lifetime.

There is a need in the industry for an effective and economical method for recycling building products, including residential roofing products. It is estimated that over 12 million tons of roofing waste are created annually. Moreover, there are additional expenses incurred in hauling and disposing of the waste. The materials present in various building products may take generations to decompose.

### BRIEF DESCRIPTION OF THE DRAWINGS

The present disclosure may be better understood, and its numerous features and advantages made apparent to those skilled in the art by referencing the accompanying drawings.

FIG. 1 includes a method for using granules, including reclaimed granules, according to an embodiment.

FIG. 2A includes a cross-sectional illustration of a granule according to an embodiment.

FIG. 2B includes a cross-sectional illustration of a granule according to an embodiment.

FIG. 3A includes a cross-sectional illustration of a core of a granule according to an embodiment.

FIG. 3B includes a cross-sectional illustration of a core of a granule according to an embodiment.

FIG. 3C includes a cross-sectional illustration of a core of a granule according to an embodiment.

FIGS. 4A and 4B include illustrations of a system for applying the granules to a building product according to an embodiment.

FIGS. 5A-5C include illustrations of a roofing shingle according to an embodiment.

FIGS. 6A and 6B include cross-sectional illustrations of roofing membranes according to an embodiment.

### DETAILED DESCRIPTION

The following description in combination with the figures is provided to assist in understanding the teachings provided herein. The following disclosure will focus on specific implementations and embodiments of the teachings. This focus is provided to assist in describing the teachings and should not be interpreted as a limitation on the scope or applicability of the teachings. However, other teachings can certainly be used in this application.

As used herein, the term “reclaimed granule” refers to a granule that has been part of a commercial product, including for example, but not limited to, a roofing product. Reclaimed granules are part of a post-consumer waste stream. Recycled granules are distinct from reclaimed granules. Recycled granules refer to granules that are recycled during a manufacturing process and are not part of a post-consumer waste stream.

The present application is directed to systems and methods for use with granules, including reclaimed granules. Some prior art references have suggested that reclaimed granules can be re-used to make new building products. In fact, some prior art references have suggested that reclaimed granules can be treated and cleaned to assist with their re-use to make new building products. However, despite these suggestions in the literature, the industry has struggled to develop a system for re-using reclaimed granules. Applicants have identified challenges associated with the use of reclaimed granules and have developed certain methods and systems according to the embodiments herein.

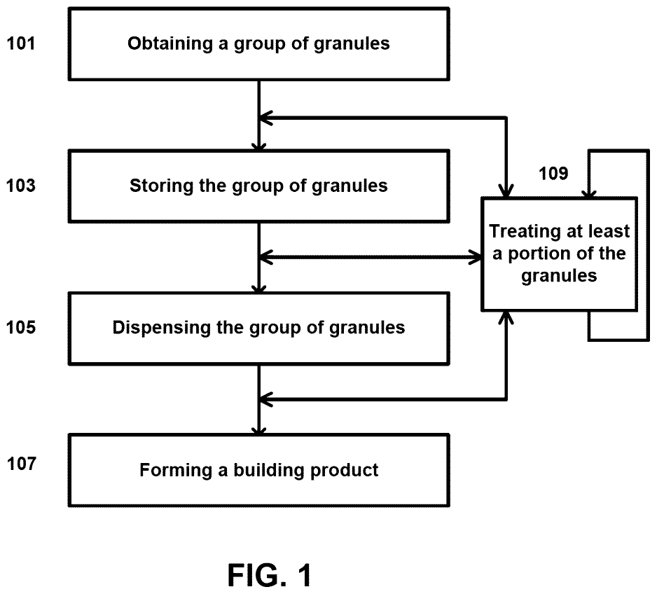

FIG. 1 includes a method for using granules, including reclaimed granules. As provided at step 101, the process can begin by obtaining a group of granules. According to an embodiment, the group of granules can include reclaimed granules. The reclaimed granules can come from a variety of post-consumer waste streams and thus have a greater variation of certain granule characteristics than virgin granules used to form the first generation of building product. The variation in granule characteristics creates challenges in the handling of reclaimed granules and deployment of the reclaimed granules into building products. In fact, it has been found that even small contents of reclaimed granules within a group of granules can have an unexpected impact on the storage, handling, and deployment of the group of granules.

According to one embodiment, the group of granules may include at least 1 wt % reclaimed granules for a total weight of the granules. In another embodiment, the content of reclaimed granules within a group of granules can be greater, such as at least 5 wt % or at least 10 wt % or at least 15 wt %, or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt % for a total weight of the group of granules. In one particular embodiment, all of the granules in the group of granules can be reclaimed granules. Still, in a non-limiting embodiment, the group of granules may include not greater than 99 wt % reclaimed granules for a total weight of the group of granules, such as not greater than 90 wt % or not greater than 80 wt % or not greater than 70 wt % or not greater than 60 wt % or not greater than 50 wt % or not greater than 40 wt % or not greater than 30 wt % or not greater than 20 wt %. It will be appreciated that the group of granules can include a weight percent of reclaimed granules within a range including any of the minimum and maximum values noted above, including for example, but not limited to, within a range of at least 1 wt % and not greater than 99 wt % or within a range of at least 20 wt % and not greater than 99 wt % or within a range of at least 40 wt % and not greater than 99 wt %.

In one embodiment, a group of granules may include a plurality of granules. In another embodiment, the group of granules can include at least 1 kg of granules, such as at least 10 kg or at least 100 kg or at least 1,000 kg or at least 10,000 kg or at least 100,000 kg. In one non-limiting embodiment, the group of granules may be an amount of granules suitable for commercial scale manufacturing of a building product.

Through empirical studies, it has been found that even small amounts of certain materials that are part of the reclaimed granules can have a notable impact on the storage, handling, and deployment of reclaimed granules. While some efforts have been made to develop processes for cleaning reclaimed granules, in practice, such processes do not completely clean the reclaimed granules.

In one embodiment, the reclaimed granules, which may be obtained after a cleaning process, may still include some minimum content of residual asphalt. For example, according to one embodiment, the reclaimed granules can include at least 0.1 wt % residual asphalt on an exterior surface of the granules for a total weight of the reclaimed granules. In other embodiments, the content of residual asphalt may be greater, such as at least 0.3 wt % or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least or at least 15 wt %, or at least 20 wt % or at least 25 wt % or at least 30 wt % or at least 35 wt % or at least 40 wt % or at least 45 wt % or at least 50 wt % for a total weight of the reclaimed granules. Still, in another non-limiting embodiment, the content of the residual asphalt on the reclaimed granules may be not greater than 90 wt % residual asphalt on an exterior surface of the granules for a total weight of the reclaimed granules, such as not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %. It will be appreciated that the content of residual asphalt on the reclaimed granules can be within a range including any of the minimum and maximum percentages noted above, including for example, but not limited to, within a range of at least 0.1 wt % and not greater than 90 wt % or within a range including at least 0.1 wt % and not greater than 50 wt % or within a range including at least 0.3 wt % and not greater than 10 wt %. The content of residual asphalt on the reclaimed granules is determined by taking a group of granules weighing not less than 50 grams and recording this as the starting weight (Ws). The group of granules are subjected to a heating process of 540° C. for a duration of 2 hours to volatilize the residual asphalt. After heating and volatilization, the group of granules are weighed again to record the end weight (We). The weight of the residual asphalt is the difference in weight between the starting weight and the end weight (i.e., weight of residual asphalt (Wre)=Ws−We). The weight percent content of residual asphalt of the reclaimed granules is calculated as (Wre/Ws)×100.

The residual asphalt can be an asphalt-containing material that may include one or more fillers that may be used in the formation of the building product. For example, in the context of some roofing products, the asphalt-containing material can be a filled asphalt coating that includes certain fillers, such as limestone. The residual asphalt may include asphalt from the building product that has aged and become adhered or attached to the exterior surface of the granule. The residual asphalt may be oxidized and/or hardened due to extended exposure to environmental elements (e.g., sun).

After obtaining the granules, the process may optionally continue at step 103, which includes storing the granules. Certain manufacturing processes may store the group of granules for a duration until they are ready for deployment onto a building product.

Referring again to FIG. 1, after storing the group of granules, the process may include dispensing the group of granules at step 105. In one aspect, the group of granules may be dispensed from the container. The group of granules may then be subject to one or more optional processes, including for example, but not limited to, sorting, separating, mixing with other materials, and the like.

Referring again to FIG. 1, the process may include treating at least a portion of the granules at step 109. In accordance with an embodiment, the process for treating at least a portion of the granules may include forming a coating on at least a portion of the granules of the group of granules. As illustrated in the embodiment of FIG. 1, the process of treating may be conducted at various stages during the process of forming a building product. For example, in one embodiment, the process of treating may be conducted after obtaining the group of granules but before storing the group of granules. In another non-limiting embodiment, the process of treating may be conducted after storing the group of granules, but before dispensing the group of granules. In yet another non-limiting embodiment, the process of treating may be conducted after the granules are dispensed but prior to their application onto a building product.

In one particular aspect, the process of treating may include treating reclaimed granules from the group of granules. In a particular embodiment, the process of treating may include treating the reclaimed granules to form a coating overlying at least a portion of residual asphalt that may be present on an exterior surface of the reclaimed granules. As will be provided in more detail in embodiments herein, the coating may be formed on the reclaimed granules, such that in certain instances, the coating may overlie at least a portion of the residual asphalt present on the reclaimed granules. Treating the group of granules, and in particular, reclaimed granules, to form a coating can facilitate improved storage, handling, and distribution of the granules as such a coating may be configured to limit negative interactions of the residual asphalt during processing. This is particularly useful if the coating process is conducted in a manner to facilitate at least partial coverage of residual asphalt on the exterior surfaces of the reclaimed granules.

In a particular aspect, the coating on the reclaimed granules can have a suitable alkalinity, pigment fixation, and/or surface energy to function and behave as virgin granules. According to one embodiment, the granules can have a 5-minute alkalinity ranging from about 0.1 to 1.5, such as about 0.1 to about 0.3 and a 21-hour alkalinity ranging from about 0.3 to 3.0, such as about 0.3 to about 0.5. The alkalinity test provides a measure of the unbound, soluble alkali metal content remaining in a ceramic coating made from reacting an alkali metal silicate and an aluminosilicate clay. The silicate binder reacts (when calcined at temperatures preferably at about 500° C.) with an aluminosilicate clay, and the reaction product forms a water insoluble ceramic coating. The remaining soluble alkali metal (most typically in the form of NaCl or other alkali metal chloride) is an indirect measure of the extent of insolubilization of the ceramic coating. For the 5-minute alkalinity test, for each test run, 100 milliliters (ml) of boiling water was poured into an Erlenmeyer flask (which had previously been boiled free of soluble alkali).

Twenty five gms of granules to be tested were added to the boiling water as were 3 drops of phenolphthalein indicator (turning point pH=9, where “pH” is defined as the negative base ten logarithm of the hydrogen ion concentration). The water, granules and indicator were boiled for a period of 5 minutes. Decantation of the boiling water was performed into an Erlenmeyer flask. Approximately 10 ml of fresh cold distilled water was then added onto the boiled granules and swirled. The water was then added to the original boiled water that had already been decanted. The total amount of water was then titrated to endpoint using a digital buret titration device commercially available from the Brinkmann Company. If the solution was pink immediately after addition of the indicator, that indicated the solution had a pH above 9.0, so the solution was titrated with acid, (sulfuric acid (0.1N)). If the solution was not pink immediately after addition of the indicator, the solution had a pH less than 9.0, and thus needed to be titrated to end-point using a base, (0.1N sodium hydroxide). The ml of acid or base required to reach end-point is called the “alkalinity”. The alkalinity is positive when using acid, negative when using base. The following is the process as provided in U.S. Pat. No. 5,411,803 .

The procedure for 21-hour alkalinity is provided in U.S. Pat. No. 5,411,803 and is similar to the 5-minuyte Alkalinity Test, except that after the granules were added to the distilled water, the flask is stoppered and then placed in an oven maintained at 49° C. for 21 hours. After 21 hours, the solution in each case was decanted into a clean 250 ml Erlenmeyer flask and the granules rinsed once with 10 ml of cold distilled water. The rinse water was added to the decanted solution, 3 drops of phenolphthalein added, and the solutions titrated as in the 5-minute alkalinity test.

In one embodiment, the process of treating may be conducted at a particular temperature suitable for manufacturing a coating for overlying residual asphalt and also suitable for the use of the granules in a building product. For example, in one instance, treating may include forming a coating at a temperature of less than 450° F., such as less than 425° F. or less than 400° F. or less than 375° F. or less than 350° F. or less than 325° F. or less than 300° F. or less than 275° F. or less than 250° F. or less than 225° F. or less than 200° F. or less than 175° F. or less than 150° F. or less than 125° F. or less than 100° F. or less than 80° F. Still, in one non-limiting embodiment, the coating process may be conducted at a temperature of at least 30° F. such as at least 40° F. or at least 50° F. or at least 60° F. It will be appreciated that the temperature used during treating can include a temperature within a range including any of the minimum and maximum values noted above, including for example, but not limited to at least 30° F. and not greater than 450° F. or within a range of at least 30° F. and not greater than 300° F. or even within a range of at least 50° F. and not greater than 200° F. Without wishing to be tied to a particular theory, the treating temperature may also be controlled to limit any negative interactions of the residual asphalt with the coating.

In accordance with an embodiment, the coating process may use one or more coating processes, including for example, but not limited to fluidized bed coating, encapsulation (e.g., encapsulation by gelation), chelation, solvent evaporation, coacervation, vesicle formation, spinning disk encapsulation, or any combination thereof.

In certain instances, the process of treating may include an evaluation process prior to the coating process. For example, the granules for treating may be evaluated for asphalt content, particle size distribution, and/or density prior to coating, wherein such an evaluation may be used to facilitate a coating process configured to create a coating that may be suitable to create a coating for overlying residual asphalt and use in a building product. In one aspect, the data gathered by the evaluation may be used to select and/or adapt coating process parameters.

In another aspect, the process of treating the group of granules may include some sorting prior to conducting the coating process. For example, in one embodiment, only a portion of the group of granules may be treated. In a more particular embodiment, the evaluation process may be used to sort the reclaimed granules having a certain content of residual asphalt from the granules that do not have residual asphalt. In one embodiment, only the reclaimed granules with residual asphalt may be subject to the treating process. Still, in another non-limiting embodiment, the entire group of granules may be subject to the coating process, wherein the group of granules after treating may include granules without residual asphalt and a coating and granules with residual asphalt underlying a coating.

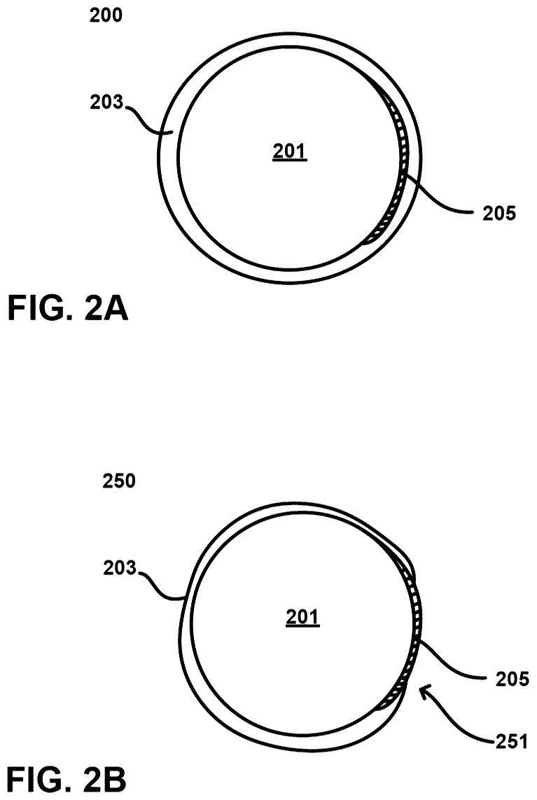

FIG. 2A includes a cross-sectional illustration of a granule according to an embodiment. As illustrated by the granule 200 may include a core 201, a coating 203 overlying the core 201, and an asphalt-containing region 205 disposed between the core 201 and the coating 203.

According to one embodiment, the core 201 may include an organic material, an inorganic material, or a combination thereof. In one particular embodiment the core may include an organic material from the group of a thermoplastic polymer, a thermoset polymer, a filled polymer, a naturally-occurring material (e.g., rubber, wood, etc.), an epoxy, a polymer-containing composite (e.g., polymer-sand composite, a fiber-reinforced polymer), or any combinations thereof. In a particular embodiment, the organic material may include a material from the group of high density polyethylene, low density polyethylene, polypropylene, polystyrene, acrylonitrile butadiene styrene (ABS), polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBS), styrene butadiene rubbers (SBR), styrene-ethylene/butylene)-crystalline block copolymer (SEBC), acrylic, or any combinations thereof.

In another aspect, the core 201 may include an inorganic material, such as a material from the group of oxides, carbides, nitrides, borides, or any combination thereof. In one non-limiting embodiment, the core 201 may include a mineral, such as a naturally-occurring mineral. In another embodiment, the core 201 can include a material and/or be made essentially of a material from the group of rhyolite, quartz, feldspar, nepheline syenite, shale, granite, limestone, basalt, slate, andesite, dacite, diabase, kaolin clay, aluminum fluoride, Portland cement, silica, phosphate, titanate, zirconia, zirconate, aluminate, iron oxide, or any combination thereof. In one particular instance, the mineral may include a silicate material, and more particularly, may be a silicate-based material including a majority content of silicate. In yet another embodiment, the inorganic material may include a glass-containing material.

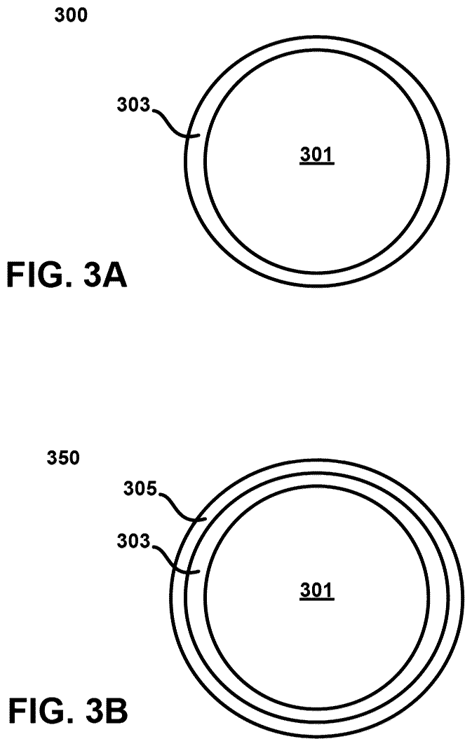

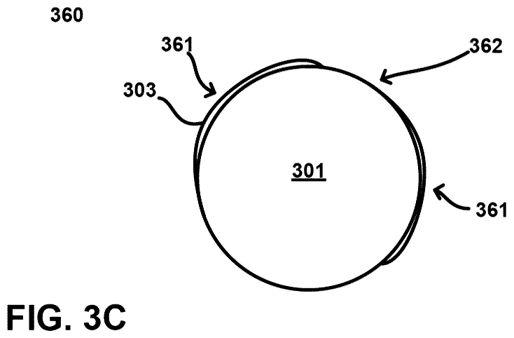

In one or more embodiments, the core of the granules herein may include a one or more films overlying a central core. FIG. 3A includes a cross-sectional illustration of a core of a granule according to an embodiment. In one aspect, the core 300 may include a central core 301 and one or more films 303 overlying the central core 301. According to one embodiment, the central core 301 may have a first composition and the one or more films 303 may have a different composition as compared to the composition of the central core 301. In a particular instance, the central core 301 can include any of the compositions associated with the core as described in embodiments herein. In another aspect, the one or more films 303 may include any of the compositions associated with the core or the coating as described in embodiments herein.

FIG. 3B includes a cross-sectional illustration of a core according to an alternative embodiment. As provided, the core 350 may include a central core 301, a first film 303 overlying and in direct contact with the central core 301. The core 350 may further include a second film 305 overlying the central core 301 and the first film 303. As illustrated, the second film 305 maybe in direct contact with at least a portion of the first film 303. According to the embodiments herein, an asphalt-containing region, such as the asphalt containing region 205, maybe overlying the core and in direct contact with an exterior surface of an outermost film of one or more films making up the core 201.

According to an embodiment, the one or more films of the embodiments herein may include a biocidal agent, a pigment, a solar reflective material, a dispersant agent, a foaming agent, an antifoaming, agent, a viscosity modifier, a pigment, a colorant, a special effect pigment (like metal flakes), an iridescent/pearlescent pigment, an IR reflective material, or any combinations thereof.

According to an embodiment, the one or more films of the embodiments herein may include a pigment including any one or more materials from the group of a titanium-containing species, a cobalt-containing species, a barium-containing species, a vanadium-containing species, a zinc-containing species, a chromium-containing species, an aluminum-containing species, an iron-containing species, a manganese-containing species, a nickel-containing species, or any combination thereof.

In yet another embodiment, the one or more films of the embodiments herein may include a polymeric material, including for example, but not limited to, polysiloxane, polyurea, polyurethane, silane modified ether, silane modified ester, silane modified polyurethane, silane modified polyurea, epoxy, acrylic, polyacrylic, or any precursors that will crosslink after application to form such polymers, or any combination of the above.

In a particular instance, the one or more films, such as film 303 overlying the central core 301, may have a particular average thickness. For example, the one or more films 303 may have an average thickness of at least 1 micron, such as at least 10 microns or at least 25 microns or at least 50 microns or at least 75 microns. Still, in one non-limiting embodiment, the one or more films may have an average thickness that is not greater than 200 microns, such as not greater than 90 microns or not greater than 80 microns or not greater than 70 microns or not greater than 60 microns or not greater than 50 microns. It will be appreciated that the average thickness of the one or more films may be within a range including any of the minimum and maximum values noted above.

According to another aspect, the one or more films 303 overlying the central core 301 may be formed as a continuous layer. For example, the one or more films 303 may be a generally conformal layer enveloping the central core 301.

Still, in one non-limiting embodiment, the one or more films may be a discontinuous layer of material overlying the central core. In such embodiments, the discontinuous layer may be characterized by a plurality of discrete regions, such as islands of material, on an exterior surface of the central core including one or more openings between the discrete regions. For example, FIG. 3C includes a cross-sectional illustration of a core of a granule according to an embodiment. As illustrated, the core 360 can include a central core 301 and a film 303 as a discontinuous layer made up of one or more regions 361 and an exposed region 362 of the central core 301 that is not covered by the one or more regions 361.

According to an embodiment, the core 201 may have a particular size. For example, the core may have an average size (D50) of at least 1 micron, such as at least 10 microns or at least 50 microns or at least 100 microns or at least 250 microns or at least 500 microns or at least 750 microns or at least 1 mm or at least 2 mm or at least 3 mm or at least 4 mm. Still, in one non-limiting embodiment, the core 201 may have an average size of not greater than 10 mm, such as not greater than 9 mm or not greater than 8 mm or not greater than 7 mm or not greater than 6 mm or not greater than 5 mm or not greater than 4 mm. It will be appreciated that the average size of the core 201 may be within a range including any of the minimum and maximum values noted above, including for example, within a range of at least 1 micron and not greater than 10 mm.

According to another aspect, the asphalt containing region 205 may include or define a region of asphalt overlying the core 201 that includes oxidized asphalt. As understood by the disclosure of the embodiments herein, reclaimed granules may include some content of residual asphalt on an exterior surface, which may be an oxidized asphalt-containing material.

According to one embodiment, the asphalt containing region 205 may overlie a particular percentage of the entire surface of the core 201. For example, in one embodiment, the asphalt-containing region may be overlying not greater than 99% of an entire surface of the core 201, such as not greater than 98% or not greater than 95% or not greater than 90% or not greater than 80% or not greater than 70% or not greater than 60% or not greater than 50% or not greater than 40% of not greater than 30% or not greater than 25% or not greater than 20% or not greater than 15% or not greater than 10% or not greater than 8% or not greater than 6% or not greater than 5% or not greater than 4% or not greater than 3% or not greater than 2% of the entire surface of the core. In still another non-limiting embodiment, the asphalt-containing region may be overlying at least 0.1% of the entire surface of the core 201, such as at least 0.3% or at least 0.5% or at least 1% or at least 2% or at least 3% or at least 4% or at least 5% or at least 8% or at least 10% or at least 12% or at least 15% or at least 18% or at least 20%. It will be appreciated that the asphalt-containing region 205 may be overlying a percentage of the surface of the core within a range including any of the minimum and maximum percentages noted above, including for example, within a range of at least 0.1% and not greater than 99%, such as within a range of at least 1% and not greater than 90% or within a range of at least 2% and not greater than 80%.

In yet another aspect, the asphalt-containing region 205 may be a discrete region that may not necessarily extend around the entire peripheral surface of the core 201. In one instance, the asphalt-containing region 205 can define a discontinuous coating overlying the peripheral surface of the core 201. For example, the asphalt-containing region 205 may be a discrete region covering not more than 90% of a total circumference of the core 201 as viewed in a cross-section of the granule 200, such as not greater than 80% or not greater than 70% or not greater than 60% or not greater than 50% or not greater than 40% or not greater than 30% or not greater than 20% or not greater than 10%. Still, in one non-limiting embodiment, the asphalt-containing region 205 may be a discrete region representing at least 0.1% of a total circumference of the core 201 as viewed in a cross-section of the granule 200, such as at least 0.3% or at least 0.5% or at least 1% or at least 2% or at least 3% or at least 4% or at least 5% or at least 7% or at least 8% or at least 10% or at least 20% or at least 30% or at least 40% or at least 50% of the total circumference of the core 201. It will be appreciated that the asphalt-containing region 205 may be a discrete region as viewed in cross-section overlying a portion of the core 201 that is within a range including any of the minimum and maximum percentages noted above.

In certain instances, the coating process may be conducted such that the coating 203 can be overlying at least a portion of the asphalt-containing region 205. In one embodiment, the coating 203 may be in direct contact with the asphalt-containing region 205. In a more particular embodiment, the coating 203 may be in direct contact with the asphalt-containing region 205 and overlying at least a portion of the asphalt-containing region 205. For example, in certain instances, the coating 203 may overlie a majority of the asphalt containing region 205. In a more particular embodiment, the coating 203 may overlie at least 10% of the asphalt-containing region 205 and as viewed in cross-section. For another embodiment, the coating 203 may overlie at least 20% such as at least 30% or at least 40% or at least 50% or at least 60% or at least 70% or at least 80% or at least 90% or at least 95% of the asphalt-containing region 205. In one embodiment, the coating 203 can be overlying the entirety of the asphalt-containing region 205 as viewed in cross-section.

FIG. 2B includes a cross-sectional illustration of a granule 250 according to an embodiment. As illustrated, the granule 250 can include a core 201, a coating 203 overlying the core 201, and an asphalt containing region 205 disposed between the coating 203 and the core 201. As illustrated, the coating 203 may not necessarily overlie the entirety of the asphalt containing region 205, such that at least a portion of the asphalt containing region 205 may define an exterior surface 251 of the granule 250.

In one particular aspect, the coating 203 may include a particular material suitable for use with granules configured to be used in building products. In one particular instance, the coating 203 may have a particular composition suitable for both use as a granule for a building product and also suitable as a material that may cover and/or adhere to the asphalt-containing regions 205 present on at least a portion of the reclaimed granules.

According to one embodiment, the coating 203 may include an organic material, and inorganic material, or any combination thereof. In one aspect, the coating 203 can include any one or more materials listed herein as materials suitable for use in the core or one or more films of the core particles as provided in any of the embodiments herein. For example, in one instance, the coating 203 may include an organic material from the group of a thermoplastic polymer, a thermoset polymer, a filled polymer, a naturally-occurring material (e.g., rubber, wood, etc.), an epoxy, a polymer-containing composite (e.g., polymer-sand composite, a fiber-reinforced polymer), or any combinations thereof. In a particular embodiment, the organic material may include a material from the group of high density polyethylene, low density polyethylene, polypropylene, polystyrene, acrylonitrile butadiene styrene (ABS), polyamides, polyesters, polycarbonate, polyvinyl chloride, polymethyl methacrylate, polyglycolic acid, polyhydroxy butyrate, polyurethanes, polyureas, epoxy, polydimethylsiloxane (PDMS), poly(styrene-butadiene-styrene) (SBS), styrene butadiene rubbers (SBR), styrene-ethylene/butylene)-crystalline block copolymer (SEBC), acrylic, polyvinyl butyral, vinyl esters, styrene-acrylics, or any combinations thereof.

In yet another embodiment the coating 203 may include an inorganic material such as an oxide, carbide, nitride, boride, or any combination thereof. In a particular instance, the coating 203 can include a material and/or be made essentially of a material from the group of rhyolite, quartz, feldspar, nepheline syenite, shale, granite, limestone, basalt, slate, kaolin clay, aluminum fluoride, Portland cement, silica, phosphate, titanate, zirconia, zirconate, aluminate, iron oxide, or any combination thereof. In one particular instance, the mineral may include a silicate material, and more particularly, may be a silicate-based material including a majority content of silicate. In yet another embodiment, the inorganic material may include a glass-containing material.

In yet another instance, the coating may include a material configured to reflect certain types of electromagnetic radiation, which may facilitate improved storing, handling and/or deployment of the group of granules 203. For example, in one embodiment, the coating may include a material having a reflectivity of at least 25% for electromagnetic energy within a wavelength of 300-3000 nm according to testing standard ASTM E903 (Standard Test Method for Solar Absorptance, Reflectance, and Transmittance of Materials Using Integrating Spheres). Still, in another embodiment, the reflectivity may be greater, such as at least 60% or at least 70% or at least 80% or at least 90% for electromagnetic energy within a wavelength of 300-3000 nm.

For another embodiment, the coating, in its entirety, may be configured to reflect certain types of electromagnetic radiation, which may facilitate improved storing, handling and/or deployment of the group of granules 203. For example, the coating may have a reflectivity of at least 50% for electromagnetic energy within a wavelength of 300-3000 nm according to testing standard ASTM E903 (Standard Test Method for Solar Absorptance, Reflectance, and Transmittance of Materials Using Integrating Spheres). Still, in another embodiment, the reflectivity may be greater, such as at least 60% or at least 70% or at least 80% or at least 90% for electromagnetic energy within a wavelength of 300-3000 nm.

In yet another instance, the group of granules may have a particular thermal emittance value according to ASTM E408. For example, in one embodiment, group of granules may have an emittance of at least 5% or at least 10% or at least 15% or at least 20% or at least 25% or at least 30% or at least 35% or at least 40% or at least 45% or at least 50% or at least 55% or at least 60% or at least 65% or at least 70% or at least 75% or at least 80% or at least 85% or at least 90% or at least 95% or at least 97%. Still, in another embodiment, the thermal emittance may be not greater than 99.9% or not greater than 99% or not greater than 98% or not greater than 97% or not greater than 96% or not greater than 95%. It will be appreciated that the thermal emittance can be within a range including any of the minimum and maximum percentages noted above, including for example, but not limited to, within a range of at least 5% and not greater than 99.9% or within a range including at least 50% and not greater than 99.9% or within a range including at least 80% and not greater than 99%.

The coating 203 may be formed such that it has suitable adhesion to the asphalt-containing region 205 and core 201, while providing preferred properties associated with granules for use in building products. According to an embodiment, the coating 203 may have an adhesion to bitumen containing materials that is suitable for its use in building products. As asphalt ages the materials within the asphalt can be oxidized due to exposure to UV radiation and can begin to leech metals with exposure to moisture. As such, reclaimed granules containing residual asphalt that are not coated or coated with materials that allow diffusion can leech metals causing a yellow discoloration. Thus, the uncoated granules or granules that are coated with materials that have an open porosity, allow environmental factors to interact with the asphalt on the reclaimed granules. However, the coating 203 can have a closed porosity that limits the leaching of transition metals seen in residual asphalt. In one embodiment, the granules with the coating 203 can have little to no open porosity. In one words, the residual asphalt on the reclaimed granules does not interact with or is not affected by moisture or other environmental factors. In one embodiment, the coating 203 can limit the diffusion of copper and zinc. In one embodiment, the coating 203 can limit the leaching of copper in a reclaimed granule to be less than 2 ppm of copper. In another embodiment, the coating 203 can limit the leaching of zinc in a reclaimed granule to be less than 70 ppm of zinc.

A leaching test was conducted to determine the amount of transition metals diffusing from asphalt containing granules with the coating 203. Approximately 2 grams of coated grains with residual asphalt, as described above, were placed into each of two 50ml plastic centrifuge tubes. 20 ml of aqua regia was added to both samples to dissolve the phases in the coating. The centrifuge tubes were then placed in boiling water for 5 minutes. After 5 minutes, one tube was removed, and 5 ml were transferred to a new container. After 20 minutes, the second tube was removed, and 5 ml were transferred to a new container. The collected aliquot was diluted with DI water (1:1). The collected solutions were analyzed by ICP-OES to check for the presence of zinc and copper. About 0.5 grams of the grain were used to determine the total grain composition. Approximately 0.5 grams of the sample were fused with 4.0 grams of lithium tetraborate until a clear melt was obtained. The melt was then dissolved in 10% HCl and analyzed by ICP-OES using the Alumina method. Elemental analysis of alumina-based materials were determined by Inductively Coupled Plasma-Optical Emission Spectroscopy. Samples from the first tube and the second tube contained less than 10 ppm of copper, such as less than 5 ppm of copper, such as less than 2 ppm of copper, such as less than 1.6 ppm of copper. Samples from the first tube and the second tube contained less than 85 ppm of zinc, such as less than 80 ppm of zinc, such as less than 75 ppm of zinc, such as less than 70 ppm of zinc. On going studies continue to measure the coating characteristics of reclaimed granules as described above versus barrier layers with an open porosity that still allow interactions between the asphalt on reclaimed granules and environmental factors.

In another aspect, the processes herein may facilitate the formation of a group of granules for use in building products, wherein at least a portion of the granules are reclaimed granules having a coating as provided in embodiments herein. Depending upon particular process parameters as well as the intended end use of the granules, the content of reclaimed granules and the plurality of granules may vary. Reference herein to a plurality of granules can be the same as the group of granules as described in embodiments herein. Moreover, the group of granules including coated reclaimed granules can have any of the characteristics of the group of granules as described in embodiments herein, including for example, but not limited to the amount of granules in the group of granules, the content of residual asphalt in the group of granules, and the content of reclaimed granules in the group of granules.

According to one embodiment, the group of granules may include a portion of reclaimed granules and a portion of virgin granules. The virgin granules may be free of an asphalt-containing region. As will be appreciated, the group of granules configured to be distributed onto a building product may include coated reclaimed granules including an asphalt-containing region at least partially underlying a coating as provided in embodiments herein.

According to one embodiment, the group of granules including reclaimed granules may have a particular density variation. In particular, the group of granules including reclaimed granules may have a greater density variation than conventional groups of granules used in building products, as the reclaimed granules can come from a variety of sources unlike virgin granules that represent a well-controlled raw material stream. Furthermore, a group of granules including reclaimed granules having a coating may further increase a density variation of the group of granules, which may pose additional challenges in the proper storage, handling, and distribution of the group of granules onto a building product. In at least one embodiment, the group of granules including reclaimed granules can have a density variation of at least 0.20 g/cc, such as at least 0.22 g/cc or at least 0.24 g/cc or at least 0.26 g/cc or at least 0.28 g/cc or at least 0.30 g/cc or at least 0.32 g/cc or at least 0.34 g/cc or at least 0.36 g/cc or at least 0.38 g/cc or at least 0.40 g/cc or at least 0.42 g/cc or at least 0.44 g/cc or at least 0.46 g/cc or at least 0.48 g/cc or at least 0.50 g/cc or at least 0.52 g/cc or at least 0.54 g/cc or at least 0.56 g/cc or at least 0.58 g/cc or at least 0.60 g/cc or at least 0.62 g/cc or at least 0.64 g/cc or at least 0.66 g/cc at least 0.68 g/cc or at least 0.70 g/cc or at least 0.80 g/cc or at least 0.90 g/cc. Still, in one non-limiting embodiment, the density variation of the group of granules including reclaimed granules can be not greater than 5 g/cc, such as not greater than 4 or not greater than 3 or not greater than 2 or not greater than 1.8 or not greater than 1.6 or not greater than 1.5 or not greater than 1.4 or not greater than 1.3 or not greater than 1.2 or not greater than 1. It will be appreciated that the group of granules may have a density variation within a range including any of the minimum and maximum values noted above, including for example, but not limited to, within a range of at least 0.20 g/cc and not greater than 5 g/cc, such as within a range of at least 0.22 g/cc and not greater than 4 g/cc or even within a range including at least 0.24 g/cc and not greater than 2 g/cc. As used herein, reference to density variation is reference to the maximum and minimum values of density for a statistically relevant sample size of granules of the group of granules.

According to another embodiment, the group of granules may have a particular particle size distribution that is different as compared to conventional groups of granules used to form building products. In particular, the group of granules including reclaimed granules may have a greater particle size distribution standard deviation than conventional groups of granules used in building products, as the reclaimed granules can come from a variety of sources and the coating may further alter the particle size distribution of some or all granules in the group. The greater particle size distribution standard deviation may pose additional challenges in the proper storage, handling, and distribution of the group of granules onto a building product.

In yet another instance, the group of granules may have a particular variation in shape that is different as compared to conventional group of granules used to form building products. In particular, the group of granules including reclaimed granules may have shapes from at least two or more of the groups of shapes including spherical, cuboidal, acicular, angular/sub-angular, pyramids, truncated pyramids, truncated cubes, triangles, cones, tetrahedras, hemispheres and any combinations thereof.

Referring again to FIG. 1, as described herein, the coating process can be conducted on the group of granules, which may include only reclaimed granules or a mix of reclaimed granules and virgin granules. In at least one embodiment, the coating process may create a group of coated granules, wherein the group of coated granules can each have the same coating defining their exterior surface, but may have define a first population and a second population, wherein the first population has at least one characteristics that is different as compared to the characteristic in the second population, wherein the at least one characteristic is from the group of a) a core material underlying the coating, b) a density, c) an asphalt content, d) one or more intermediate layers between a core and the coating, e) or any combination of a), b), c), and/or d).

According to one aspect, the group of granules may include reclaimed granules from a variety of sources, wherein the reclaimed granules may have a different core material as compared to each other, different densities compared to each other, different asphalt contents, and different constructions (e.g., core and coating configurations). Accordingly, after the coating process, the reclaimed granules may each have a same exterior coating layer, but may have one or more different characteristics as provided above.

According to another embodiment, the group of granules may include a fraction of reclaimed granules mixed with virgin granules, wherein the entire group of granules may be subject to the coating process. In such instances, the reclaimed granules may have a different core material as compared to each other and the portion of virgin granules, different densities compared to each other and the portion of virgin granules, different asphalt contents compared to each other and the virgin granules, and different constructions (e.g., core and coating configurations) compared to each other and the virgin granules. Accordingly, after the coating process, the reclaimed granules and virgin granules may each have a same exterior coating layer but may have one or more different characteristics as provided above.

According to another aspect, it will be appreciated that the coating process may be conducted more than one time and may be used to apply a series of coatings to the group of granules. As illustrated in FIG. 1, it is contemplated that in at least one embodiment, the process of treating can be conducted one or more times. For example, in at least one embodiment, at least a portion of the group of granules may be treated a first time to form a first coating, such as a pigmented coating. After the first coating is formed, at least a portion of the granules or all of the granules having the first coating can be treated a second time to form a second coating, such as an adhesion promoter, which may overlie at least a portion of the first coating. The second coating can have any one or more features of the coatings as described in embodiments herein.

Referring again to FIG. 1, after treating at least a portion of the granules at step 109 and/or dispensing the group of granules at step 105, at least a portion of the group of granules may be used to form a building product as provided at step 107.

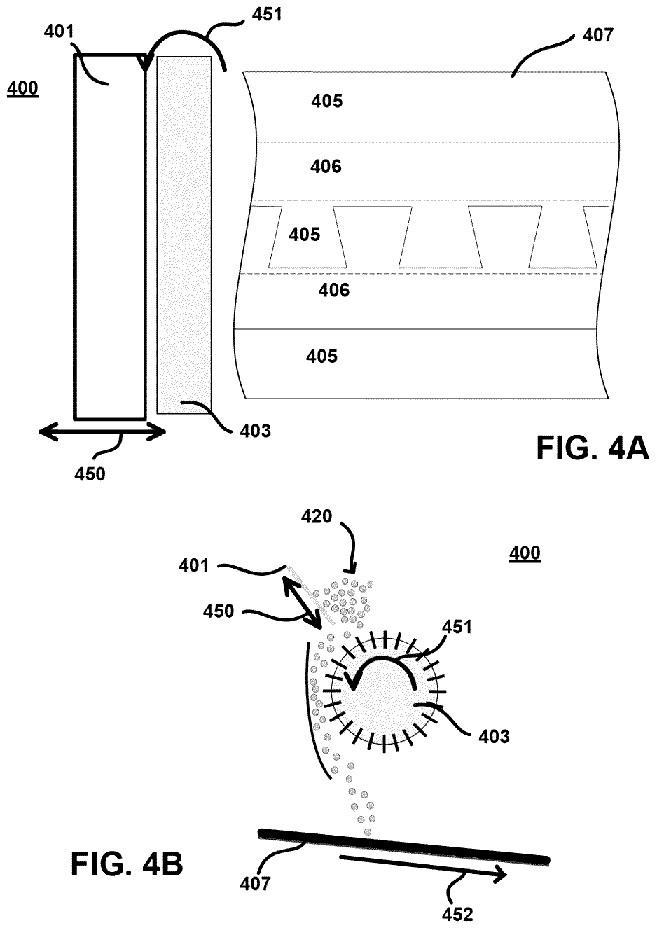

FIG. 4A include the top down schematic distribution device used to distribute granules according to embodiments herein onto a building product. FIG. 4B includes a side view illustration of the distribution device illustrated in FIG. 4A. As provided in the illustrated embodiments of FIGS. 4A and 4B, a distribution device 400 can include a first portion 401 and a roller 403. The first portion 401 may be configured to translate in a direction generally 450 and the roller 403 may be configured to rotate generally, for example, in the direction 451. The granules 420 may be dispensed from the distribution device 400 around the roller portion 403 and dropped onto a building product 407 being translated relative to the distribution device 400 generally in the direction 452. As such, as the granules are distributed from the distribution device 400 onto the building product 407 and form a layer of granules on the surface of the building product 407.

The building product 407 may be divided into a plurality of sections, including for example, sections 405 and 406, which may define different portions of a building product after further processing. For example, in one embodiment sections 405 may define uncovered regions of a multilayer building product after the building product 407 is further processed and assembled. Sections 406 may define covered portions of a building product after the building product 407 is further processed and assembled. According to an embodiment, the granules of the embodiments herein may be suitable for distribution onto one or more sections 405 and 406 of a building product. It will be appreciated that the sections 405 and 406 of the building products 407 may be arranged in different ways depending upon the particular manufacturing process. Reference to the building product will be understood as reference to the finally-formed building product or intermediate product that is configured to form a building product after further processing. As understood in the industry, one or more layers asphalt-containing layers may be applied to a substrate, wherein the granules are applied to the asphalt-containing layer under conditions where the granules can adhere to the asphalt-containing layer.

According to an embodiment, one type of building product that can include the group of granules may include a roofing product. In one aspect, the roofing product may include a roofing membrane or roofing shingle. In one aspect, the roofing shingle may have a multilayered construction including a lower layer and an upper layer. The lower layer can include a headlap and a plurality of tabs extending from the headlap. The upper layer can include one or more fingers disconnected from one another. The one or more fingers can be arranged along an upper surface of the lower layer—particularly, along the tabs and headlap. In an embodiment, each tab of the lower layer can include no more than one finger, but certain tabs may be free, or essentially free, (such as devoid) of a finger. In certain instances, at least one of the fingers can extend across an entire width of the lower layer. In other embodiments, at least one of the fingers can extend a distance different than the width of the lower layer, such as less than the width of the lower layer. An impact resistant material can be coupled to the lower layer of the roofing shingle, providing dampening against impacting objects.

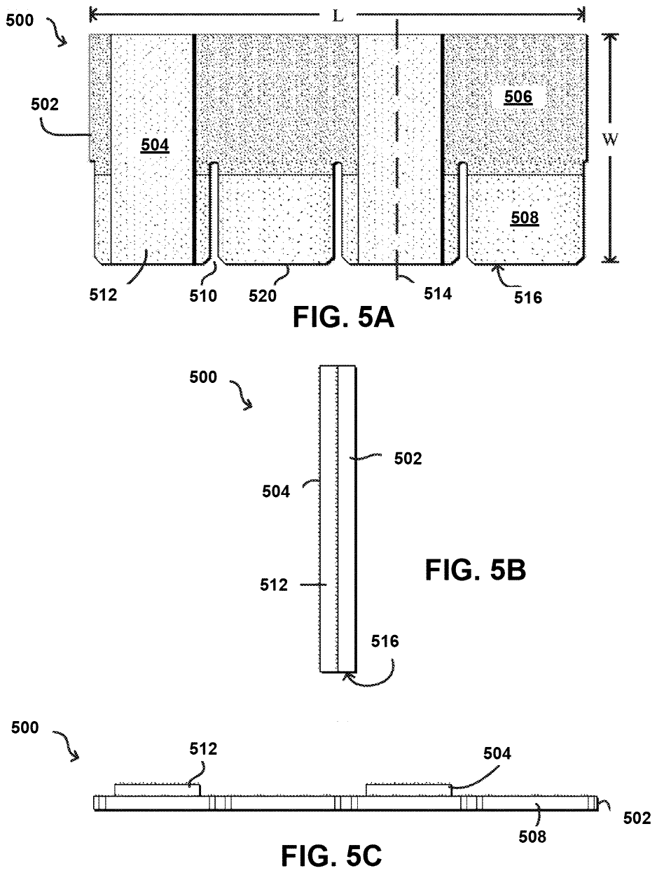

Referring to FIGS. 5A, 5B, and 5C, a roofing shingle 500 (hereinafter, “shingle”), in accordance with embodiments described herein, may include a lower layer 502 and an upper layer 504. In an embodiment, the lower layer 502 may form a lowermost layer of the shingle 500. In another embodiment, the upper layer 504 may form an uppermost layer of the shingle 500. In a particular instance, the shingle 500 can be free, or essentially free, (such as devoid) of additional layers such as a tertiary layer along the lowermost surface of the lower layer 502, along the uppermost surface of the upper layer 504, or along both the lowermost surface of the lower layer 502 and the uppermost surface of the upper layer 504. In another instance, one or more elements can be positioned along the lowermost surface of the lower layer 502, along the uppermost surface of the upper layer 504, or along both the lowermost surface of the lower layer 502 and the uppermost surface of the upper layer 504. Examples of laminated shingle configurations are described in U.S. Pat. No. 6,145,265, which is incorporated herein in its entirety.

The lower layer 502 can include a headlap 506 extending along a length, L, and at least partially along a width, W, of the shingle 500 and one or more tabs 508 extending from the headlap 506. The headlap 506 can be polygonal such as rectangular, or generally rectangular. Installed, the headlap 506, or a portion thereof, is typically covered by an overlying shingle 500.

In an embodiment, the lower layer 502 may include only one tab 508 extending between a left edge and a right edge of the shingle 500. That is, the shingle 500 may be free, or essentially free, of slots otherwise separating adjacent tabs. In another embodiment, the lower layer 502 may include a plurality of tabs 508, such as two tabs, three tabs, four tabs, or five tabs extending from the headlap 506. In yet another aspect, the lower layer 502 can include more than five tabs, such as at least six tabs, at least seven tabs, at least eight tabs, at least nine tabs, or even at least ten tabs.

In a particular embodiment, the tabs 508 can all extend equidistance from the headlap 506. For example, the tabs 508 may extend at least 5% of the width, W, of the shingle 500, such as at least 10% W, at least 20% W, at least 30% W, at least 40% W, or even at least 50% W. In an embodiment, the tabs 508 may extend less than W, such as less than 99% W, less than 90% W, less than 80% W, less than 70% W, or less than 60% W.

Still, it will be appreciated that in certain instances, the tabs 508 can extend different distances from the headlap 506 toward a butt end 516 of the shingle 500. In some embodiments, the butt end 516 may be variegated.

Referring again to FIGS. 5A-5C, the tabs 508 can extend from the headlap 506 in a uniform, or generally uniform, direction with respect to one other. Adjacent tabs 508 can be spaced apart by slots 510 extending parallel, or generally parallel, with the width, W, of the shingle 500. In certain embodiments, the slots 508 can have uniform characteristics with respect to one another. For example, the slots 508 can all have a same width, as measured parallel with the width, W, of the shingle 500, a same length, as measured perpendicular to the width, W, a same area, a same shape as compared to one another, or a combination thereof. In an embodiment, at least one of the slots 510 can extend past the tabs 508 into the headlap 506. In a particular instance, the at least one slot 510 can extend at least 1% into the width of the headlap, such as at least 5% into the width of the headlap, at least 10% into the width of the headlap, or even at least 25% of the width of the headlap. In another instance, the at least one slot 510 can extend no greater than 75% the width of the headlap, no greater than 50% of the width of the headlap, or no greater than 30% the width of the headlap.

In one non-limiting embodiment, at least one of the slots 510 can extend a different distance into the headlap 506 than a slot 510 along the same or different shingle 500. In a different embodiment, all of the slots 510 can extend a same distance into the headlap 506. At least one of the slots 510 can terminate with a rounded end, a polygonal end, or an end having rounded and polygonal attributes. As illustrated in FIG. 5A, the slot 510 can terminate at the butt end 516 of the shingle 500 with a flared opening.

In an embodiment, at least one of the slots 510 may be closed, or fully surrounded by portions of the lower layer 502. That is, the at least one slot 510 may have a perimeter defined entirely by the lower layer 502, i.e., the slot is not open and does not terminate at the butt end 516. In a particular embodiment, the shingle 500 can include a combination of open and closed slots 510. In another particular embodiment, adjacent tabs 508 can be spaced apart by multiple slots 510, such as multiple closed slots. The closed slots can optionally all lie along a same line extending from the butt end 516 of the shingle 500 to the headlap 506.

In a particular instance, one or more of the slots 510 can be slits having no discernable length, as measured parallel with a length, L, of the shingle 500. Slits can break surface textures, changing aesthetic appearance of the shingle 500 without material removal. In certain embodiments, the slots 510 can have different lengths as compared to one another, as measured parallel with the length, L, of the shingle 500. In other embodiments, the slots 510 can have the same, or relatively similar, lengths as one another, as measured parallel with the length, L.

The shingle 500 in accordance with embodiments described herein can further include fingers 512 as part of the upper layer 504. According to an embodiment, fingers 512 can selectively overlie a portion of or all of the tabs 508. In one embodiment, each finger 512 can extend from the headlap 506 to the butt end 516 of the respective tabs 508. In one aspect, the upper layer 504 can include one or more fingers 512, such as for example, at least one finger, at least two fingers, at least three fingers, at least four fingers, or even at least five fingers. Each finger of the one or more fingers 512 can be aligned with a tab 508 of the lower layer 502. In an embodiment, each of the one or more fingers 512 may be disposed on one tab 508. In another embodiment, each tab 508 may include no more than one finger 512. In certain embodiments, each tab 508 may include one finger 512. In certain other instances, the total number of tabs 508 may be different than the total number of fingers 512. The disclosure is not intended to be limited to this exemplary configuration and other arrangements between tabs 508 and fingers 512 are contemplated by this disclosure.

By way of a non-limiting embodiment, the fingers 512 can be attached to the lower layer 502, for example, by an adhesive, mechanical fastener, mechanical deformation, threaded or non-threaded fasteners, or any combination thereof.

The relative width of the tabs 508 and fingers 512 may be varied for the desired construction and/or aesthetic. For example, the tabs 508 may have different widths as compared to each other.

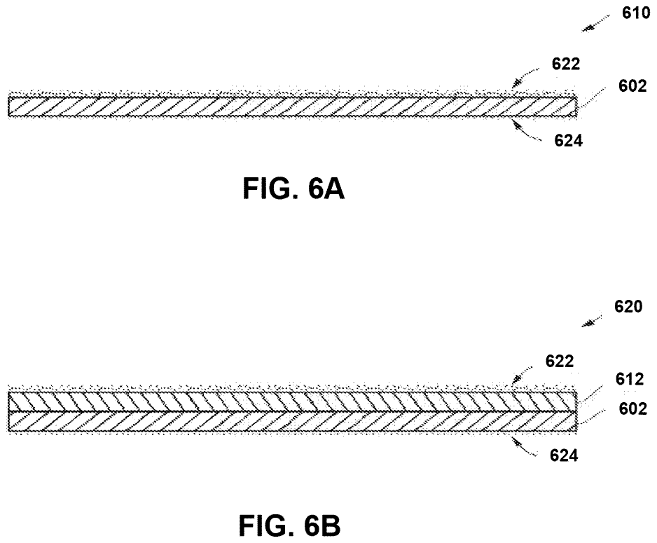

FIG. 6A includes a cross-sectional illustration of a roofing product, such as a roofing membrane, according to an embodiment. The roofing product 610 can include a coated base material 602 that may include a roofing-grade asphalt mixture. Roofing granules 622 may be applied to a principal surface of the coated base material 602. The roofing granules 622 can include the group of granules as provided in the embodiments herein. In certain embodiments, a parting agent 624 may be applied to an opposite principal surface of the coated based material 602, which may facilitate the application of the product to a surface.

FIG. 6B includes a cross-sectional illustration of a roofing product, such as a roofing membrane, according to an embodiment. As illustrated, the roofing product 620 can include a coated base material 602, roofing granules 622 and parting agent 624 as previously described with respect to the roofing product of FIG. 6A. The roofing product 620 may further include a roofing-grade asphalt coating 621 that is disposed between the coated base material 602 and the roofing granules 622. The roofing-grade asphalt coating 612 can include a roofing-grade asphalt mixture. The roofing-grade asphalt coating 612 may have substantially the same composition or a different composition as compared to the roofing-grade asphalt mixture within the coated base material 602.

### EMBODIMENTS

Embodiment 1: A granule configured for use in a building product, wherein the granule comprises: a core; a coating overlying the core; and an asphalt-containing region disposed between the core and the coating.

Embodiment 2: The granule of any one or more embodiments, wherein the core comprises at least one of an organic material, an inorganic material, or a combination thereof.

Embodiment 3: The granule of any one or more embodiments, wherein the core comprises an organic material from the group of a thermoplastic polymer, a thermoset polymer, a filled polymer, recycled polymer latexes, thermoplastic elastomers, a naturally-occurring material (e.g., rubber, wood, etc.), an epoxy, a polymer-containing composite (e.g., polymer-sand composite, a fiber-reinforced polymer), or any combinations thereof.

Embodiment 4: The granule of any one or more embodiments, wherein the core comprises an inorganic material from the group of oxides, carbides, nitrides, borides, or any combination thereof.

Embodiment 5: The granule of any one or more embodiments, wherein the core comprises a mineral selected from the group of rhyolite, quartz, feldspar, nepheline syenite, shale, granite, limestone, basalt, slate, andesite, dacite, diabase, igneous rock or any combination thereof.

Embodiment 6: The granule of any one or more embodiments, wherein the core includes a central core and one or more films overlying the central core.

Embodiment 7: The granule of any one or more embodiments, wherein the asphalt-containing region is in direct contact with an exterior surface of the outer most film of the one or more films overlying the central core.

Embodiment 8: The granule of any one or more embodiments, wherein the central core has a first composition, and one or more films have a different composition as compared to a composition of the central core.

Embodiment 9: The granule of any one or more embodiments, wherein the one or more films include a biocidal agent, a pigment, a solar reflective material, a dispersant agent, a foaming agent, an antifoaming, agent, a viscosity modifier, a pigment, a colorant, a special effect pigment (like metal flakes), an iridescent/pearlescent pigment, fire retardants, hydrophobic additives, film-forming agents, an IR reflective material, or any combinations thereof.

Embodiment 10: The granule of any one or more embodiments, wherein the one or more films comprise an average thickness of at least 1 micron and not greater than 200 microns.

Embodiment 11: The granule of any one or more embodiments, wherein the one or more films define a continuous layer of material overlying the central core.

Embodiment 12: The granule of any one or more embodiments, wherein the one or more films define a discontinuous layer of material overlying the central core.

Embodiment 13: The granule of any one or more embodiments, wherein the core comprises an average size (D50) within a range of at least 1 micron and not greater than 10 mm.

Embodiment 14: The granule of any one or more embodiments, wherein the asphalt-containing region includes a region of asphalt overlying the core including oxidized asphalt.

Embodiment 15: The granule of any one or more embodiments, wherein the asphalt-containing region is overlying not greater than 99% of an entire surface of the core, such as not greater than 98% or not greater than 95% or not greater than 90% or not greater than 80% or not greater than 70% or not greater than 60% or not greater than 50% or not greater than 40% of not greater than 30% or not greater than 25% or not greater than 20% or not greater than 15% or not greater than 10% or not greater than 8% or not greater than 6% or not greater than 5% or not greater than 4% or not greater than 3% or not greater than 2% of the entire surface of the core.

Embodiment 16: The granule of any one or more embodiments, wherein the asphalt-containing region is overlying at least 0.1% of the entire surface of the core, such as at least 0.3% or at least 0.5% or at least 1% or at least 2% or at least 3% or at least 4% or at least 5% or at least 8% or at least 10% or at least 12% or at least 15% or at least 18% or at least 20%.

Embodiment 17: The granule of any one or more embodiments, wherein the asphalt-containing region is a discrete region that does not extend around the entire peripheral surface of the core.

Embodiment 18: The granule of any one or more embodiments, wherein the asphalt-containing region is a discrete region representing not more than 90% of a total circumference of the core as viewed in a cross-section of the granule or not greater than 80% or not greater than 70% or not greater than 60% or not greater than 50% or not greater than 40% or not greater than 30% or not greater than 20% or not greater than 10%.

Embodiment 19: The granule of any one or more embodiments, wherein the asphalt-containing region is a discrete region representing at least 0.1% of a total circumference of the core as viewed in a cross-section of the granule or at least 0.3% or at least 0.5% or at least 1% or at least 2% or at least 3% or at least 4% or at least 5% or at least 7% or at least 8% or at least 10% or at least 20% or at least 30% or at least 40% or at least 50%.

Embodiment 20: The granule of any one or more embodiments, wherein the asphalt-containing region defines a discontinuous coating overlying the peripheral surface of the core.

Embodiment 21: The granule of any one or more embodiments, wherein the coating is overlying at least a portion of the asphalt-containing region.

Embodiment 22: The granule of any one or more embodiments, wherein the coating is overlying a majority of the asphalt-containing region.

Embodiment 23: The granule of any one or more embodiments, wherein the coating is overlying at least 10% of the asphalt-containing region, or at least 20% or at least 30% or at least 40% or at least 50% or at least 60% or at least 70% or at least 80% or at least 90% or at least 95%.

Embodiment 24: The granule of any one or more embodiments, wherein the coating is overlying all of the asphalt-containing region.

Embodiment 25: The granule of any one or more embodiments, wherein the coating is in direct contact with the asphalt-containing region.

Embodiment 26: The granule of any one or more embodiments, wherein the coating is in direct contact with the asphalt-containing region and overlying a majority of the asphalt-containing region.

Embodiment 27: The granule of any one or more embodiments, wherein the coating includes at least material selected from the group of an organic material, an inorganic material, or any combination thereof.

Embodiment 28: The granule of any one or more embodiments, wherein the coating includes an organic material selected from the group of a thermoplastic polymer, a thermoset polymer, a filled polymer, recycled polymer latexes, thermoplastic elastomers, a naturally-occurring material (e.g., rubber, wood, etc.), an epoxy, a polymer-containing composite (e.g., polymer-sand composite, a fiber-reinforced polymer), or any combinations thereof.

Embodiment 29: The granule of any one or more embodiments, wherein the inorganic material includes at least one material from the group of oxides, carbides, nitrides, borides, or any combination thereof.

Embodiment 30: The granule of any one or more embodiments, wherein the coating is adhered to the core.

Embodiment 31: A building product including the granule of any one or more embodiments.

Embodiment 32: The building product of embodiment 31, wherein the building product is a membrane or shingle.

Embodiment 33: The building product of embodiment 31, wherein the building product includes a multilayered shingle.

Embodiment 34: The building product of embodiment 31, wherein the granule is disposed in a covered region, an uncovered region, or both a covered region and an uncovered region of the building product.

Embodiment 35: A group of granules for use in building products, the group comprising: a portion of reclaimed granules, wherein the reclaimed granules comprise: a core; a coating overlying the core; and an asphalt-containing region disposed between the core and the coating.

Embodiment 36: The group of granules of any one or more embodiments, wherein at least 1 wt % of the group of granules are reclaimed granules or at least 2 wt % or at least 3 wt % or at least 4 wt % or at least 5 wt % or at least 8 wt % or at least 10 wt % or at least 15 wt % or at least 20 wt % or at least 25 wt % or at least 30 wt % or at least 35 wt % or at least 40 wt % or at least 45 wt % or at least 50 wt % or at least 55 wt % or at least 60 wt % or at least 65 wt % or at least 70 wt % or at least 75 wt % or at least 80 wt % or at least 85 wt % or at least 90 wt % or at least 95 wt % or at least 98 wt %.

Embodiment 37: The group of granules of any one or more embodiments, wherein not greater than 99 wt % of the granules are reclaimed granules, or not greater than 98 wt % or not greater than 95 wt % or not greater than 90 wt % or not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %.

Embodiment 38: The group of granules of any one or more embodiments, wherein each granule of the group of granules is a reclaimed granule.

Embodiment 39: The group of granules of any one or more embodiments, further comprising a portion of the group of granules including virgin granules, wherein the virgin granules are free of an asphalt-containing region.

Embodiment 40: The group of granules of any one or more embodiments, wherein the reclaimed granules include at least 0.3 wt % residual asphalt on an exterior surface for a total weight of the reclaimed granules, or at least 0.5 wt % or at least 1 wt % or at least 2 wt % or at least 3 wt % or at least 4 wt % or at least 5 wt % or at least 6 wt % or at least 7 wt % or at least 8 wt % or at least 9 wt % or at least 10 wt % or at least or at least 15 wt %, or at least 20 wt % or at least 25 wt % or at least 30 wt % or at least 35 wt % or at least 40 wt % or at least 45 wt % or at least 50 wt %.

Embodiment 41: The group of granules of any one or more embodiments, wherein the reclaimed granules include not greater than 90 wt % residual asphalt on an exterior surface for a total weight of the reclaimed granules, or not greater than 80 wt % or not greater than 70 wt % or not greater than 60 wt % or not greater than 50 wt % or not greater than 40 wt % or not greater than 30 wt % or not greater than 20 wt % or not greater than 15 wt % or not greater than 10 wt % or not greater than 8 wt % or not greater than 6 wt %.

Embodiment 42: The group of granules of any one or more embodiments, wherein the core comprises at least one of an organic material, an inorganic material, or a combination thereof.

Embodiment 43: The group of granules of any one or more embodiments, wherein the organic material from the group of a thermoplastic polymer, a thermoset polymer, a filled polymer, a naturally-occurring material (e.g., rubber, wood, etc.), an epoxy, a polymer-containing composite (e.g., polymer-sand composite, a fiber-reinforced polymer), or any combinations thereof.

Embodiment 44: The group of granules of any one or more embodiments, wherein the core comprises an inorganic material from the group of oxides, carbides, nitrides, borides, or any combination thereof.

Embodiment 45: The group of granules of any one or more embodiments, wherein the core comprises a mineral selected from the group of rhyolite, quartz, feldspar, nepheline syenite, shale, granite, limestone, basalt, slate, or any combination thereof.

Embodiment 46: The group of granules of any one or more embodiments, wherein the core includes a central core and one or more films overlying the central core.

Embodiment 47: The group of granules of any one or more embodiments, wherein the asphalt-containing region is in direct contact with an exterior surface of the outer most film of the one or more films overlying the central core.

Embodiment 48: The group of granules of any one or more embodiments, wherein the central core has a first composition, and one or more films have a different composition as compared to a composition of the central core.

Embodiment 49: The group of granules of any one or more embodiments, wherein the one or more films include a biocidal agent, a pigment, a solar reflective material, a dispersant agent, a foaming agent, an antifoaming, agent, a viscosity modifier, a pigment, a colorant, a special effect pigment (like metal flakes), an iridescent/pearlescent pigment, an IR reflective material, or any combinations thereof.

Embodiment 50: The group of granules of any one or more embodiments, wherein the one or more films comprise an average thickness of at least 1 micron and not greater than 200 microns.

Embodiment 51: The group of granules of any one or more embodiments, wherein the one or more films define a continuous layer of material overlying the core.

Embodiment 52: The group of granules of any one or more embodiments, wherein the one or more films define a discontinuous layer of material overlying the core.

Embodiment 53: The group of granules of any one or more embodiments, wherein the core comprises an average size (D50) within a range of at least 1 micron to not greater than 10 mm.

Embodiment 54: The group of granules of any one or more embodiments, wherein the asphalt-containing region includes a region of asphalt overlying the core including oxidized asphalt.

Embodiment 55: The group of granules of any one or more embodiments, wherein the asphalt-containing region is overlying not greater than 99% of an entire surface of the core, such as not greater than 98% or not greater than 95% or not greater than 90% or not greater than 80% or not greater than 70% or not greater than 60% or not greater than 50% or not greater than 40% of not greater than 30% or not greater than 25% or not greater than 20% or not greater than 15% or not greater than 10% or not greater than 8% or not greater than 6% or not greater than 5% or not greater than 4% or not greater than 3% or not greater than 2% of the entire surface of the core.

Embodiment 56: The group of granules of any one or more embodiments, wherein the asphalt-containing region is overlying at least 0.1% of the entire surface of the core, such as at least 0.3% or at least 0.5% or at least 1% or at least 2% or at least 3% or at least 4% or at least 5% or at least 8% or at least 10% or at least 12% or at least 15% or at least 18% or at least 20%.

Embodiment 57: The group of granules of any one or more embodiments, wherein the asphalt-containing region is a discrete region that does not extend around the entire peripheral surface of the core.

Embodiment 58: The group of granules of any one or more embodiments, wherein the asphalt-containing region is a discrete region representing not more than 90% of a total circumference of the core as viewed in a cross-section of the granule or not greater than 80% or not greater than 70% or not greater than 60% or not greater than 50% or not greater than 40% or not greater than 30% or not greater than 20% or not greater than 10%.

Embodiment 59: The group of granules of any one or more embodiments, wherein the asphalt-containing region is a discrete region representing at least 0.1% of a total circumference of the core as viewed in a cross-section of the granule or at least 0.3% or at least 0.5% or at least 1% or at least 2% or at least 3% or at least 4% or at least 5% or at least 7% or at least 8% or at least 10% or at least 20% or at least 30% or at least 40% or at least 50%.

Embodiment 60: The group of granules of any one or more embodiments, wherein the asphalt-containing region defines a discontinuous coating overlying the peripheral surface of the core.

Embodiment 61: The group of granules of any one or more embodiments, wherein the coating is overlying at least a portion of the asphalt-containing region.

Embodiment 62: The group of granules of any one or more embodiments, wherein the coating is overlying a majority of the asphalt-containing region.

Embodiment 63: The group of granules of any one or more embodiments, wherein the coating is overlying at least 10% of the asphalt-containing region, or at least 20% or at least 30% or at least 40% or at least 50% or at least 60% or at least 70% or at least 80 % or at least 90% or at least 95%.

Embodiment 64: The group of granules of any one or more embodiments, wherein the coating is overlying the entire asphalt-containing region.

Embodiment 65: The group of granules of any one or more embodiments, wherein the coating is in direct contact with the asphalt-containing region.

Embodiment 66: The group of granules of any one or more embodiments, wherein the coating is in direct contact with the asphalt-containing region and overlying a majority of the asphalt-containing region.

Embodiment 67: The group of granules of any one or more embodiments, wherein the coating includes at least material selected from the group of an organic material, an inorganic material, or any combination thereof.

Embodiment 68: The group of granules of any one or more embodiments, wherein the organic material is selected from the group of a thermoplastic polymer, a thermoset polymer, a filled polymer, a naturally-occurring material (e.g., rubber, wood, etc.), an epoxy, a polymer-containing composite (e.g., polymer-sand composite, a fiber-reinforced polymer), or any combinations thereof.

Embodiment 69: The group of granules of any one or more embodiments, wherein the inorganic material is selected from the group of oxides, carbides, nitrides, borides, or any combination thereof.

Embodiment 70: The group of granules of any one or more embodiments, wherein the coating is adhered to the core.

Embodiment 71: A building product including the group of granules of any one of the embodiments herein.

Embodiment 72: The building product of embodiment 71, wherein the building product is a membrane or shingle.

Embodiment 73: The building product of embodiment 71, wherein the building product includes a multilayered shingle.

Embodiment 74: The building product of embodiment 71, wherein the group of granules is disposed in a covered region, an uncovered region, or both a covered region and an uncovered region of the building product.

Embodiment 75: The group of granules of any one or more embodiments, wherein the reclaimed granules comprise a density variation of at least 0.20 g/cc, such as at least 0.22 g/cc or at least 0.24 g/cc or at least 0.26 g/cc or at least 0.28 g/cc or at least 0.30 g/cc or at least 0.32 g/cc or at least 0.34 g/cc or at least 0.36 g/cc or at least 0.38 g/cc or at least 0.40 g/cc or at least 0.42 g/cc or at least 0.44 g/cc or at least 0.46 g/cc or at least 0.48 g/cc or at least 0.50 g/cc or at least 0.52 g/cc or at least 0.54 g/cc or at least 0.56 g/cc or at least 0.58 g/cc or at least 0.60 g/cc or at least 0.62 g/cc or at least 0.64 g/cc or at least 0.66 g/cc at least 0.68 g/cc or at least 0.70 g/cc or at least 0.80 g/cc or at least 0.90 g/cc.

Embodiment 76: A group of granules configured for attachment to a building product, each granule of the group of granules comprising: a coating, wherein the coating of the group of the granules is the same coating, and wherein the group of granules comprises a first population and a second population, wherein the first population has at least one characteristics that is different as compared to the same characteristic in the second population, wherein the at least one characteristic is from the group of: a) a core material underlying the coating; b) a density; c) an asphalt content; d) one or more intermediate layers between a core and the coating; e) or any combination of a), b), c), and/or d).

Embodiment 77: The group of granules of any one or more embodiments, wherein the granules have any one or more features of any one or more claims herein.

Embodiment 78: A method for treating granules for use in building products, the method comprising: obtaining reclaimed granules, wherein at least a portion of reclaimed granules have a content of residual asphalt on a surface; and treating the reclaimed granules to form a coating overlying at least a portion of the residual asphalt, wherein treating includes forming the coating at a temperature of less than 450° F.

Embodiment 79: The method of embodiment 78, wherein treating includes a coating process from the group of fluidized bed coating, encapsulation by gelation, chelation, solvent evaporation, coacervation, vesicle formation, spinning disk encapsulation, or a combination thereof.

Embodiment 80: The method of embodiment 78, wherein the reclaimed granules include any one or more features of any one or more claims herein.

Embodiment 81: The granule of any one or more embodiments, wherein the coating prevents leaching of metals from the granule.

Embodiment 82: The granule of any one or more embodiments, wherein the coating has a closed porosity to metals.

Embodiment 83: The granule of any one or more embodiments, wherein the granule leaches less than 2 ppm of copper.

Embodiment 84: The granule of any one or more embodiments, wherein the granule leaches less than 70 ppm of zinc.

### EXAMPLE

A coating is made on a group of granules wherein all of the granules are reclaimed granules. The coating is formed by weighing the reclaimed granules, which weigh approximately 300 grams, and pouring them into a fluidizing chamber of a fluidized bed coating system. A polymeric coating formulation is formed by weighing approximately 175 g of the polymeric material (30% diluted) and stirring it continuously at 300-400 rpm. The coating process is initiated by introducing the reclaimed granules into the chamber and heating the granules until they reach a temperature of 50° C. The polymeric coating is introduced into the system through a liquid inlet port (communicated to the spray nozzle) via a peristaltic pump. The process uses an atomization pressure of approximately 10-15 psi to spray the mist of polymeric coating into the bed of fluidizing reclaimed granules. The process is conducted until all of the coating material is consumed. The coated granules are cooled and disposed on a tray for drying in an oven at ˜100-110 ° C. The coating on the granules contain 18% combination pH buffer, dispersant, and anti-foaming agent, 33% combination filler and pigment, 42% wax binder, and 7% additives (thickener, hydrophobic agent, anti-foaming agent, and adhesion promoter).

As used herein, the terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting.

Benefits, other advantages, and solutions to problems have been described above with regard to specific embodiments. However, the benefits, advantages, solutions to problems and any feature(s) that may cause any benefit, advantage, or solution to occur or become more pronounced are not to be construed as a critical, required, or essential feature of any or all the claims. Reference herein to a material including one or more components may be interpreted to include at least one embodiment wherein the material consists essentially of the one or more components identified. The term “consisting essentially” will be interpreted to include a composition including those materials identified and excluding all other materials except in minority contents (e.g., impurity contents), which do not significantly alter the properties of the material. Additionally, or in the alternative, in certain non-limiting embodiments, any of the compositions identified herein may be essentially free of materials that are not expressly disclosed. The embodiments herein include a range of contents for certain components within a material, and it will be appreciated that the contents of the components within a given material total 100%.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A granule configured for use in a building product, wherein the granule comprises:
a core;
a coating overlying the core; and
an asphalt-containing region disposed between the core and the coating.

2. The granule of claim 1, wherein the core comprises at least one of an organic material, an inorganic material, or a combination thereof.

3. The granule of claim 1, wherein the core comprises an organic material from the group of a thermoplastic polymer, a thermoset polymer, a filled polymer, recycled polymer latexes, thermoplastic elastomers, a naturally-occurring material (e.g., rubber, wood, etc.), an epoxy, a polymer-containing composite (e.g., polymer-sand composite, a fiber-reinforced polymer), or any combinations thereof.

4. The granule of claim 1, wherein the core comprises an inorganic material from the group of oxides, carbides, nitrides, borides, or any combination thereof.

5. The granule of claim 1, wherein the core comprises a mineral selected from the group of rhyolite, quartz, feldspar, nepheline syenite, shale, granite, limestone, basalt, slate, andesite, dacite, diabase or any combination thereof.

6. The granule of claim 1, wherein the core includes a central core and one or more films overlying the central core.

7. The granule of claim 6, wherein the asphalt-containing region is in direct contact with an exterior surface of the outer most film of the one or more films overlying the central core.

8. The granule of claim 6, wherein the central core has a first composition, and one or more films have a different composition as compared to a composition of the central core.

9. The granule of claim 6, wherein the one or more films include a biocidal agent, a pigment, a solar reflective material, a dispersant agent, a foaming agent, an antifoaming, agent, a viscosity modifier, a pigment, a colorant, a special effect pigment (like metal flakes), an iridescent/pearlescent pigment, an IR reflective material, or any combinations thereof.

10. The granule of claim 6, wherein the one or more films comprise an average thickness of at least 1 micron and not greater than 200 microns.

11. The granule of claim 6, wherein the one or more films define a continuous layer of material overlying the central core.

12. The granule of claim 6, wherein the one or more films define a discontinuous layer of material overlying the central core.

13. The granule of claim 1, wherein the core comprises an average size (D50) within a range of at least 1 micron and not greater than 10 mm.

14. The granule of claim 1, wherein the asphalt-containing region includes a region of asphalt overlying the core including oxidized asphalt.

15. The granule of claim 1, wherein the asphalt-containing region is overlying at least 0.1% and not greater than 99% of an entire surface of the core.

16. The granule of claim 1, wherein the coating is overlying at least a portion of the asphalt-containing region.

17. The granule of claim 1, wherein the coating is in direct contact with the asphalt-containing region.

18. The granule of claim 16, wherein the coating includes an organic material selected from the group of a thermoplastic polymer, a thermoset polymer, a filled polymer, recycled polymer latexes, thermoplastic elastomers, a naturally-occurring material (e.g., rubber, wood, etc.), an epoxy, a polymer-containing composite (e.g., polymer-sand composite, a fiber-reinforced polymer), or any combinations thereof.

19. A group of granules for use in building products, the group comprising:
a portion of reclaimed granules, wherein the reclaimed granules comprise:
a core;
a coating overlying the core; and
an asphalt-containing region disposed between the core and the coating.

20. A method for treating granules for use in building products, the method comprising:
obtaining reclaimed granules, wherein at least a portion of reclaimed granules have a content of residual asphalt on a surface; and
treating the reclaimed granules to form a coating overlying at least a portion of the residual asphalt, wherein treating includes forming the coating at a temperature of less than 450° F.
